(19) United States
(12) Patent Application Publication
(10) Pub. No.: US 2012/0060631 A1
(43) Pub. Date: Mar. 15, 2012

(54) TWO-LIP DUST-PROOF WIPER OF A BALL SCREW

(75) Inventors: Wen-Ho Hsieh, Taichung City (TW); Ying-Min Ji, Taichung City (TW)

(73) Assignee: PRECISION MOTION INDUSTRIES, INC., Taichung City (TW)

(21) Appl. No.: 13/212,302

(22) Filed: Aug. 18, 2011

(30) Foreign Application Priority Data
Sep. 10, 2010 (TW) 099130590

(51) Int. Cl. F16H 25/12; F16H 57/00

(52) U.S. Cl. 74/89.4

(57) ABSTRACT

A two-lip dust-proof wiper of a ball screw having a main ring body, with a ringed sheet, and a screwed hole, a circumferential portion and first/second flanged portions. A wiping ring surface is set into the hole. Fine interference fit can be implemented between the wiping ring surface and the periphery of the ball screw. A first wiping lip is annularly formed onto the wiping ring surface for mating with the first flanged portion, and a second wiping lip is annularly formed onto the wiping ring surface for mating with the second flanged portion, such that the first/second wiping lips are protruded at both sides of the surface. The wiping lips and the periphery of ball screw are under interference fit, the interference being larger than that of the wiping ring surface and ball screw. The protruding direction of the wiping lips runs parallel with the flanged portions.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a dust-proof wiper of a ball screw, and more particularly to an innovative one which has a two-lip dust-proof wiper through fine interference fit of the ball screw and wiping ring surface along with two wiping lips.

2. Description of Related Art Including Information Disclosed Under 37 CFR 1.97 and 37 CFR 1.98.

Multiple strict measures must be taken for the ball screws to remove external dust and metal scraps from the bolting portion of the screws and nuts, and minimize the influence arising from possible intrusion of dust and metal scraps. In this aspect, continuous efforts are made in this industry for further improvement.

The conventional ball screw is structurally designed in a way that a dust cover is generally assembled at the end of bolting portion of the screws and nuts. Besides, a wiper is often assembled into said dust cover for blocking and removing fine dust. Hence, said wiper is an integral part of dust-proofing mechanism for the ball screw, showing that the structural design is crucial to the operational smoothness, fit accuracy, service life and quality of ball screws.

More problems are faced with respect to optimization design of said wiper, since excellent wiping effect and lower frictional resistance must be considered. The stronger the interference of the wiper versus the screw, the better wiping effect and larger frictional resistance. Otherwise, the weaker interference of the wiper versus the screw, the poorer wiping effect and smaller frictional resistance. Thus, it is learnt that the design of the existing wiper structure has to be further improved for breakthrough progress.

Referring to FIG. 8, there is shown a structural view of a conventional two-lip dust-proof wiper, which is provided with two wiping lips 70 of Y-shaped profile. The ends of two wiping lips 70 and the screw's periphery 71 are under interference fit, whilst a recessed space 72 is formed between two wiping lips 70, but the recessed space 72 and the screw's periphery 71 are not under interference fit. Yet, some problems of the conventional two-lip dust-proof wiper still exist during actual applications, for instance, either of the oblique wiping lips 70 only has single-way wiping effect, but dust 73 is prone to be infiltrated into recessed space 72 not under interference fit, and the dust 73 in saturated state will cause damage against the periphery 71 of screw.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique structure of the present invention wherein the “two-lip dust-proof wiper of ball screw” comprises said main ring body, wiping ring surface and the first/second wiping lips, the mating of the two-lip dust-proof wiper and ball screw is implemented through fine interference fit of the wiping ring surface along with two wiping lips. Excellent wiping effect could be realized no matter whether the ball screw is rotated forwardly or reversely. The convexity and spacing of two wiping lips could be designed depending on the ambient characteristics, so as to adapt to the desired friction coefficients and realize excellent wiping effect with better applicability.

Based on the structural design wherein the screwed hole is mated with said heterogeneous wiping ring, with its hardness smaller than that of the main ring body, the wiping ring surface and the first/second wiping lips are formed onto inner surface of the heterogeneous wiping ring. So, the main ring body can be fabricated by materials of larger hardness for more stable and robust positioning. Meanwhile, the wiping ring surface and the first/second wiping lips can be fabricated by materials of smaller hardness but better elasticity for better flexibility and air-tight wiping capacity.

As compared with the conventional two-lip dust-proof wiper disclosed in FIG. 8, excellent wiping effect could be realized by the present invention in its bi-directional stroke. Moreover, as the wiping ring surface and two wiping lips of the present invention are under interference fit with the ball screw, this could avoid efficiently the infiltration of dust with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a plan view of the preferred embodiment of the present invention wherein said two-lip dust-proof wiper is assembled onto the ball screw.

FIG. 2 is a perspective view of the present invention wherein the two-lip dust-proof wiper and the ball screw are disassembled.

FIG. 3 is a perspective sectional view of two-lip dust-proof wiper of the present invention.

FIG. 4 is a plan sectional view of the local structure of two-lip dust-proof wiper of the present invention.

FIG. 5 is a plan sectional view of another preferred embodiment of two-lip dust-proof wiper of the present invention.

FIG. 6 is a schematic view of the two-lip dust-proof wiper of the present invention in a positioning state.

FIG. 7 is another schematic view of two-lip dust-proof wiper of the present invention in a positioning state.

FIG. 8 is a plan view of the local structure of a conventional two-lip dust-proof wiper.

### DETAILED DESCRIPTION OF THE INVENTION

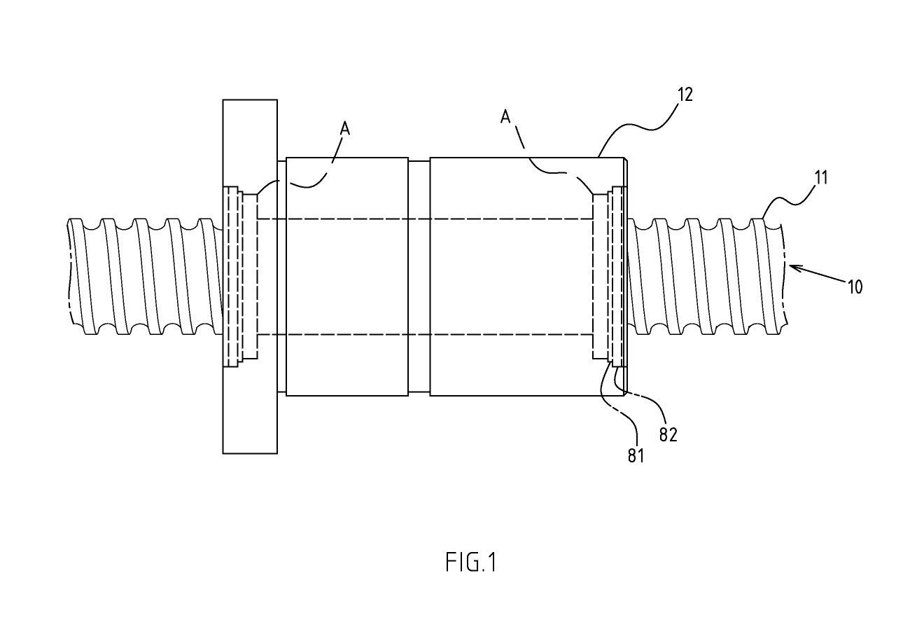

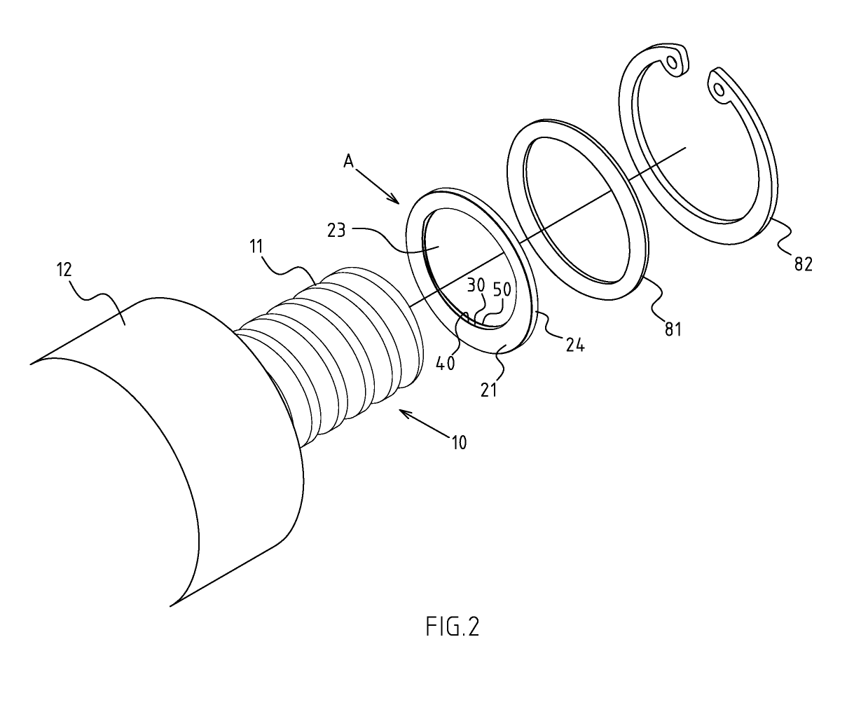

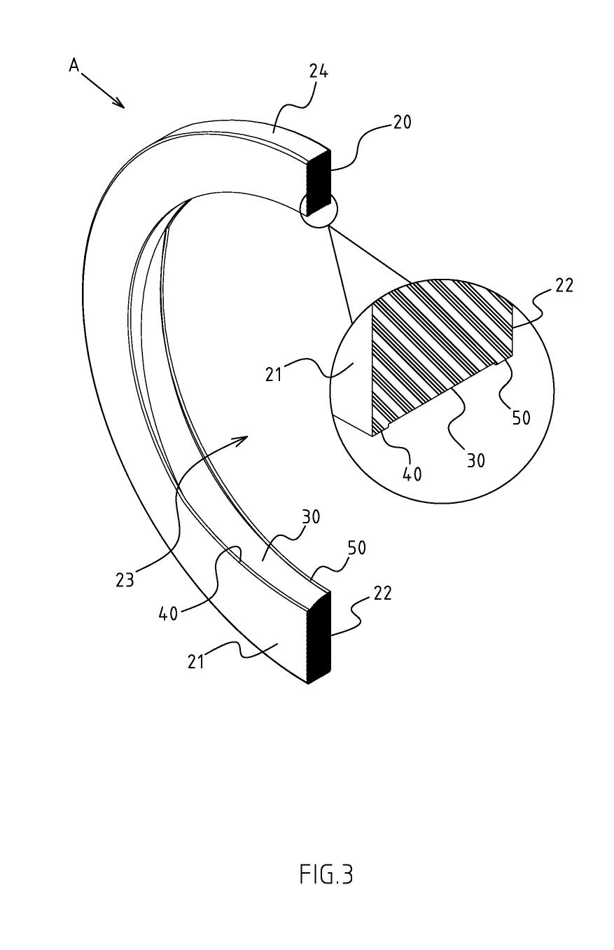

FIGS. 1-4 depict preferred embodiments of a two-lip dust-proof wiper of ball screw of the present invention, which, however, are provided for only explanatory objective for patent claims. Said two-lip dust-proof wiper A is assembled onto the periphery 11 of a ball screw 10 (disclosed in FIGS. 1, 2) for wiping out dust.

Said two-lip dust-proof wiper A comprises a main ring body 20, formed into a ringed sheet, and having a screwed hole 23, a circumferential portion 24 as well as a first flanged portion 21 and a second flanged portion 22. The main ring body 20 is made of rubber materials.

A wiping ring surface 30 is set into the screwed hole 23 in a ringed surface. Fine interference fit can be implemented between the wiping ring surface 30 and the periphery 11 of ball screw 10 (note: the periphery 11 of said ball screw 10 is defined to include threaded/threadless grooves).

A first wiping lip 40 is annularly formed onto the wiping ring surface 30 for mating with the first flanged portion 21. The first wiping lip 40 and the periphery 11 of the ball screw 10 are under interference fit, with its degree of interference larger than that of the wiping ring surface 30 and ball screw 10.

A second wiping lip 50 is annularly formed onto the wiping ring surface 30 for mating with the second flanged portion 22, such that the first/second wiping lips 40, 50 are protruded at interval at both sides of the wiping ring surface 30. The second wiping lip 50 and the periphery 11 of ball screw 10 are under interference fit, with its degree of interference larger than that of the wiping ring surface 30 and ball screw 10.

Of which, the protruding direction of the first and second wiping lips 40, 50 runs parallel with the first and second flanged portions 21, 22.

Of which, the wiping ring surface 30 is made of rubber materials or equivalents, and integrally formed into the screwed hole 23 of the main ring body 20.

Based upon above-specified structure, the present invention is operated as follows:

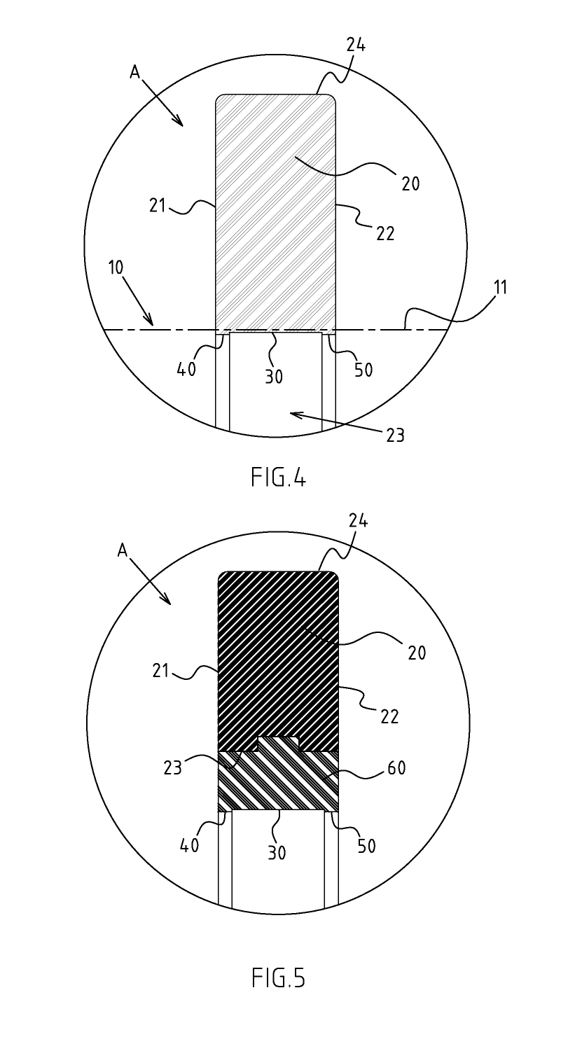

Referring to FIGS. 1 and 2, said two-lip dust-proof wiper A is assembled onto the periphery 11 of a ball screw 10, and located within the nut 12 of the ball screw 10 for wiping out dust. Two two-lip dust-proof wipers A could be assembled correspondingly onto both ends of the nuts 12. The core structural aspect of the present invention lies in that the mating of the two-lip dust-proof wiper A with the periphery 11 of the ball screw 10 is implemented by the wiping ring surface 30 and the first/second wiping lips 40, 50 under fine interference fit. Referring to FIG. 4, the inner diameter of the wiping ring surface 30 and the first/second wiping lips 40, 50 is smaller than external diameter of the periphery 11 of the ball screw 10. As the first/second wiping lips 40, 50 are protruded at interval at both sides of the wiping ring surface 30, and their protruding direction runs parallel with the first and second flanged portions 21, 22 (rather than obliquely, note that oblique wiping is restricted directionally), the first and second wiping lips 40, 50 could wipe out dust from the ball screw 10 with the same effect, no matter the ball screw 10 is rotated forwardly or reversely, whilst the wiping ring surface 30 located between the first and second wiping lips 40, 50 could yield the same dust removal effect of relatively low friction. Hence, the wiper of the present invention is perfectly suitable for wiping out dust due to its high/low friction and double-class structural pattern.

Furthermore, the wiping interference of the first/second wiping lips 40, 50 versus the ball screw 10 differs from that of the wiping ring surface 30 versus the ball screw 10, so the convexity and spacing of two wiping lips 40, 50 could be designed depending on the ambient characteristics, so as to adapt to the desired friction coefficients and realize excellent wiping effect. For instance, when the friction coefficient must be lowered down in a high-speed operating environment (machines and equipments), the wiping interference of the wiping ring surface 30 versus the ball screw 10 could be reduced. In such a case, the first and second wiping lips 40, 50 present higher convexity. However, owing to smaller contact area of the first/second wiping lips 40, 50 and the ball screw 10, the friction coefficient between the dust-proof wiper and ball screw 10 could be cut down markedly under excellent wiping effect. The spacing of the first and second wiping lips 40, 50 as well as individual width and profile shape, etc, are subject to various designs depending on the ambient environment. This could be realized through the technical features of two-lip dust-proof wiper A, which is provided with wiping ring surface 30 of high/low friction and double-class structural pattern as well as the first and second wiping lips 40, 50.

Referring to FIG. 5, the screwed hole 23 is also mated with a heterogeneous wiping ring 60, whose hardness is smaller than that of the main ring body 20 (e .g. realized by rubber materials of different hardness), such that the wiping ring surface 30 and the first/second wiping lips 40, 50 are formed onto inner surface of the heterogeneous wiping ring 60. So, the two-lip dust-proof wiper A can be fabricated by two materials. Of which, the heterogeneous wiping ring 60 is mated firmly with the screwed hole 23 of the main ring body 20 by means of secondary injection coating and fabrication forming. A rugged embedding portion is formed at the mating point of the heterogeneous wiping ring 60 and the screwed hole 23, so as to increase the mating area and improve the strength for further fixation.

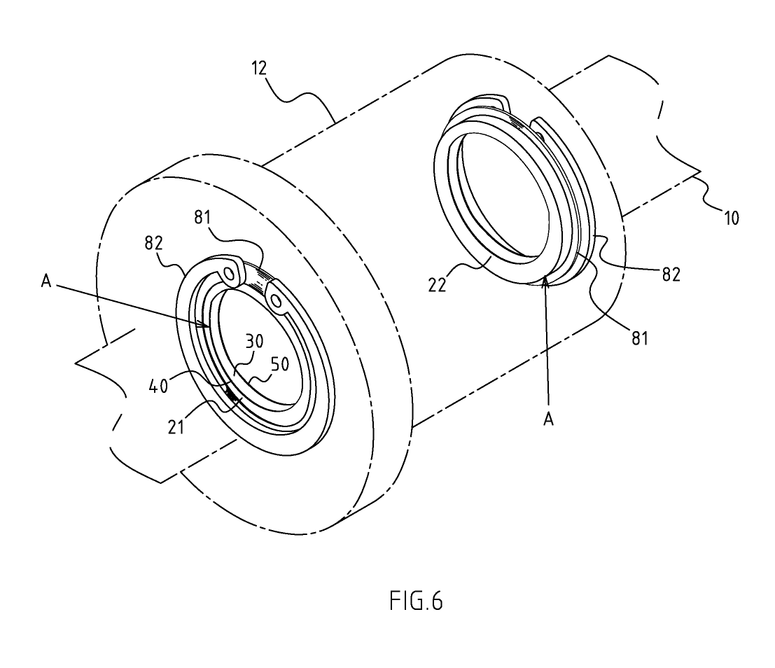

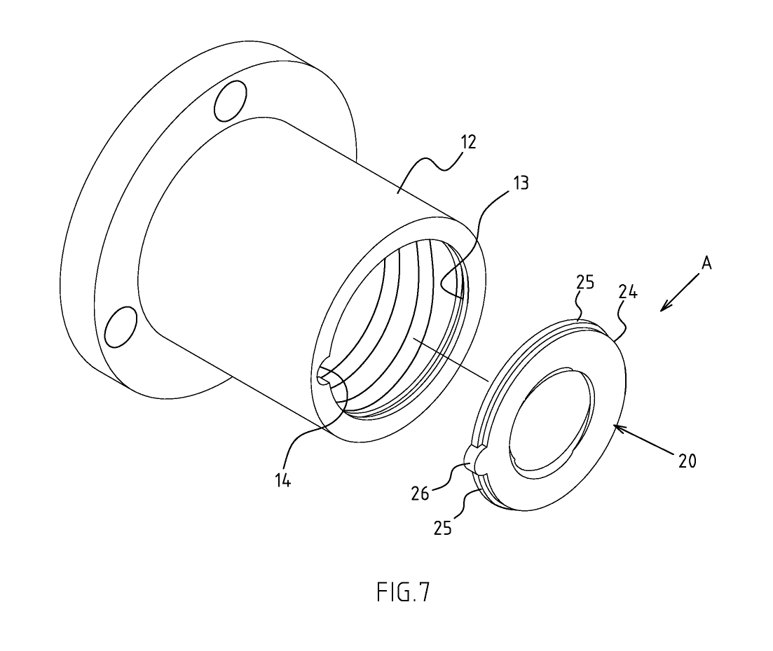

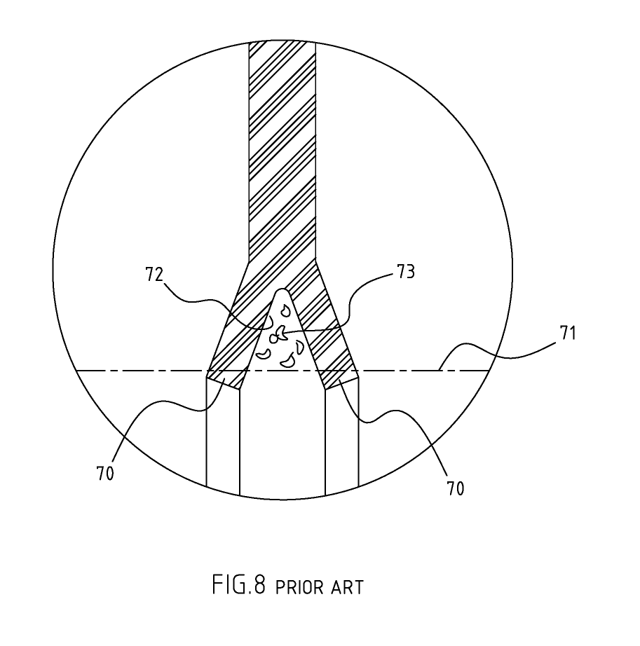

Referring also to FIG. 6, an annular lining 81 and a C-shaped snap ring 82 are also assembled in sequence adjacent to the assembly position of said two-lip dust-proof wiper A, such that the annular lining 81 is abutted onto the first flanged portion 21 (or second flanged portion 22) of said two-lip dust-proof wiper A, then the C-shaped snap ring 82 is abutted onto the annular lining 81. Meanwhile, the annular lining 81 and two-lip dust-proof wiper A are limited, and the periphery of C-shaped snap ring 82 is embedded into an annular groove preset into the nut 12. According to the structural design of the preferred embodiment, the C-shaped snap ring 82 is provided with an opening section. If the C-shaped snap ring 82 is directly abutted onto the two-lip dust-proof wiper A, complete limitation and perfect fixation cannot be realized due to gap on the abutting surface (note: especially when said two-lip dust-proof wiper is larger). Hence, said annular lining 81 is placed between the C-shaped snap ring 82 and two-lip dust-proof wiper A to realize the desired abutting effect.

Referring also to FIG. 7, a protruding flanged portion 25 and at least a rotary locating lug 26 are formed annularly onto the circumferential portion 24 of the main ring body 20, such that an annular slot 13 and at least a flanged slot 14 are set into the nut 12 of the ball screw 10 for assembly of the two-lip dust-proof wiper A. Of which, the annular slot 13 is used for positioning of the flanged portion 25 formed on the circumferential portion 24 of the main ring body 20, and the flanged slot 14 used for positioning of the rotary locating lug 26 formed on the circumferential portion 24 of the main ring body 20. So, it is possible to prevent disengagement and rotation of the two-lip dust-proof wiper A for firm positioning.

Additionally, an annular oil film spacing is reserved between the wiping ring surface 30 and the periphery of ball screw 10. In this preferred embodiment, said annular oil film spacing can be set to obtain optimum wiping effect and sealing state depending on the density of filled oil. Filling up oil in said annular oil film spacing could also guarantee the tight sealing state of the wiping ring surface 30 and the periphery of ball screw 10, thus avoiding infiltration of dust efficiently.

1. A two-lip dust-proof wiper of a ball screw, which is assembled onto the periphery of a ball screw and located within the nut of the ball screw for wiping out dust; said two-lip dust-proof wiper comprising:
a main ring body with a ringed sheet, and having a screwed hole, a circumferential portion as well as first/second flanged portions;
a wiping ring surface, set into the screwed hole in a ringed surface; and fine interference fit can be implemented between the wiping ring surface and the periphery of ball screw;
a first wiping lip, annularly formed onto the wiping ring surface for mating with the first flanged portion; the first wiping lip and the periphery of the ball screw are under interference fit, with its degree of interference larger than that of the wiping ring surface and ball screw; and
a second wiping lip, annularly formed onto the wiping ring surface for mating with the second flanged portion, such that the first/second wiping lips are protruded at interval at both sides of the wiping ring surface; the second wiping lip and the periphery of ball screw are under interference fit, with its degree of interference larger than that of the wiping ring surface and ball screw;
of which, the protruding direction of the first and second wiping lips runs parallel with the first and second flanged portions.

2. The structure defined in claim 1, wherein said wiping ring surface is made of equivalent materials, and integrally formed into the screwed hole of the main ring body.

3. The structure defined in claim 1, wherein the screwed hole is mated with a heterogeneous wiping ring, whose hardness is smaller than that of the main ring body, such that the wiping ring surface and the first/second wiping lips are formed onto inner surface of the heterogeneous wiping ring.

4. The structure defined in claim 3, wherein the heterogeneous wiping ring is mated firmly with the screwed hole by means of secondary injection coating and fabrication forming; an embedding portion is formed at the mating point of the heterogeneous wiping ring and the screwed hole, so as to increase the mating area and improve the strength.

5. The structure defined in claim 1, wherein an annular lining and a C-shaped snap ring are assembled in sequence adjacent to the assembly position of said two-lip dust-proof wiper, such that the annular lining is abutted onto a flanged portion of said two-lip dust-proof wiper, then the C-shaped snap ring is abutted onto the annular lining; meanwhile, the annular lining and two-lip dust-proof wiper are limited.

6. The structure defined in claim 1, wherein a protruding flanged portion and at least a rotary locating lug are formed annularly onto the circumferential portion of the main ring body, such that an annular slot and at least a flanged slot are set into the nut of the ball screw for assembly of the two-lip dust-proof wiper; of which the annular slot is used for positioning of the flanged portion formed on the circumferential portion of the main ring body, and the flanged slot used for positioning of the rotary locating lug formed on the circumferential portion of the main ring body; so it is possible to prevent disengagement and rotation of the two-lip dust-proof wiper for firm positioning.

7. The structure defined in claim 1, wherein said wiping ring surface and the periphery of the ball screw are under fine interference fit; and the degree of interference of the first/second wiping lips versus the periphery of the ball screw is larger than that of the wiping ring surface versus ball screw.

8. The structure defined in claim 1, wherein an annular oil film spacing is reserved between the wiping ring surface and the periphery of ball screw.
